(19) United States
(12) Patent Application Publication
(10) Pub. No.: US 2016/0299378 A1
(43) Pub. Date: Oct. 13, 2016

(54) Display Device and the Display Panel thereof

(71) Applicant: Shishuai Huang, Shenzhen City (CN)

(72) Inventor: Shishuai Huang, Shenzhen City (CN)

(73) Assignee: Shenzhen China Star Optoelectronics Technology Co. Ltd., Shenzhen, Guangdong (CN)

(21) Appl. No.: 14/006,308

(22) PCT Filed: Aug. 14, 2013
(86) PCT No.: PCT/CN2013/081470

§ 371 Date: Sep. 19, 2013

(30) Foreign Application Priority Data
Aug. 8, 2013 (CN) 2013103445303

(51) Int. Cl. G02F 1/1335

(52) U.S. Cl. CPC G02F 1/133512

(57) ABSTRACT

The present invention discloses a display device and a display panel thereof. The display panel includes a plurality of data lines set up at interval on an array substrate, a black matrix and a transparent electrode set up on a color filter substrate, and the data lines and the black matrix locate in opposition. The transparent electrode covers the black matrix, and a gap corresponding to the data lines is set up on the transparent electrode. It avoids deflection of the liquid crystal molecules of the liquid crystal layer in the gap by the above method, and thus avoids that vertical crosstalk occurs to the display panel.

### BACKGROUND OF THE INVENTION

1. Field of the Invention

The present invention relates to a liquid crystal display (LCD) technology field, more particularly, to a display device and the display panel thereof.

2. Description of the Prior Art

Conventionally, vertical crosstalk occurs to a liquid crystal display (LCD) panel because of current leakage of a thin film transistor (TFT) or a data lineline capacitance coupling, etc.

Please refer to FIG. 1, the LCD panel in the prior art comprises an array substrate 101, a color filter substrate 102 and a liquid crystal layer 103 between the array substrate 101 and the color filter substrate 102. A plurality of data lines 104 are set up at interval on the array substrate 101. A black matrix 105 and a common electrode 106 are set up on the color filter substrate 102, and the common electrode 106 is disposed on the black matrix 105. An electric field between common voltage of the common electrode 106 and data voltage of the data line 104 drives liquid crystal close to the data line 104 rotating, and therefore light penetrates the liquid crystal layer 103. If the array substrate 101 misaligns with the color filter substrate 102, the black matrix 105 fails to shield light penetrating through the liquid crystal layer 103, thereby causing vertical crosstalk.

### SUMMARY OF THE INVENTION

It is therefore a primary object of the present invention to provide a display device and a display panel thereof to avoid vertical crosstalk occurring to the display panel.

According to the present invention, a display panel comprises an array substrate, a color filter substrate and a liquid crystal layer therebetween. A plurarity of data lines are set up at interval on the array substrate. A black matrix and a transparent electrode are set up on the color filter substrate. The rarity of data lines and the black matrix locate in opposition. The transparent electrode is disposed on the black matrix, and gaps corresponding to the data lines are set up on the transparent electrode.

In one aspect of the present invention, the geps are set, up at interval along an extending direction of the plurarity of data lines.

In another aspect of the present invention, a rarity of scan lines are set up at interval and insulatvely intersect with the plurarity of data lines on the array substrate, each data line comprises a first area intersecting with one of the scan lines and a second area not intersecting with the scan lines, the gap is set up in opposition to the second area.

In another aspect of the present invention, the plurarity of data lines extend along a first direction and are set up at interval along a second direction perpendicular to the first direction, a length of the gap along the first direction is equal to or larger than that of the second area along the first direction.

In another aspect of the present invention, a length of the transparent electrode corresponding to the fiest area along the first direction is equal to or smaller than the length of the scan line along the first direction.

In another aspect of the present invention, the gaps locate on the two sides of the black matrix.

In still another aspect of the present invention, a width of the gap is larger than that of the black matrix so that the black matrix exposes through the gap.

In yet another aspect of the present invention, a difference between the length of the gap along the second direction and the length of the data lines along the second direction is equal to or larger than 10 μm and equal to or smaller than 20 μm.

According to the present invention, a display device comprises a display panel. The display panel comprises an array substrate, a color filter substrate and a liquid crystal layer therebetween. A plurarity of data lines are set up at interval on the array substrate. A black matrix and a transparent electrode are set up on the color filter substrate. The plurarity of data lines and the black matrix locate in opposition. The transparent electrode is disposed on the black matrix, and gaps corresponding to the data lines are set up on the transparent electrode.

In one aspect of the present invention, the geps are set up at interval along an extending direction of the plurarity of data lines.

In another aspect of the present invention, a plurarity of scan lines are set up at interval and insulatvely intersect with the plurarity of data lines on the array substrate, each data line comprises a first area intersecting with one of the scan lines and a second area not intersecting with the scan lines, the gap is set up in opposition to the second area.

In another aspect of the present invention, the plurarity of data lines extend along a first direction and are set up at interval along a second direction perpendicular to the first direction, a length of the gap along the first direction is equal to or larger than that of the second area along the first direction.

In another aspect of the present invention, a length of the transparent electrode corresponding to the fiest area along the first direction is equal to or smaller than the length of the scan line along the first direction.

In another aspect of the present invention, the gaps locate on the two sides of the black matrix.

In still another aspect of the present invention, a width of the gap is larger than that of the black matrix so that the black matrix exposes through the gap.

In yet another aspect of the present invention, a difference between the length of the gap along the second direction and the length of the data lines along the second direction is equal to or larger than 10 μm and equal to or smaller than 20 μm.

In contrast to prior art, the present invention sets up gaps correspnsding to date lines on a transparent electrode so that liquid crystal molecules in the gap do not deflect due to a voltage drop between the data line and the transparent electrode, thus the vertical crosstalk does not occur to the display panel.

### BRIEF DESCRIPTION OF THE DRAWINGS

FIG. 1 illustrates a schematic diagram of a conventional LCD panel.

FIG. 2 shows a display panel according to a first embodiment of the present invention.

FIG. 3 show a structure of data tines and scan lines on a array substrate of FIG. 2.

FIG. 4 shows gaps on a transparent electrode of FIG. 2.

FIG. 5 shows a display panel according to a second embodiment of the present invention.

FIG. 6 shows gaps on a transparent electrode of FIG. 5.

FIG. 7 shows a display panel according to a preferred embodiment of the present invention.

### DETAILED DESCRIPTION OF THE PREFERRED EMBODIMENTS

The invention is illustrated in detail in consideration of the following detailed description of various embodiments of the disclosure in connection with the accompanying drawings.

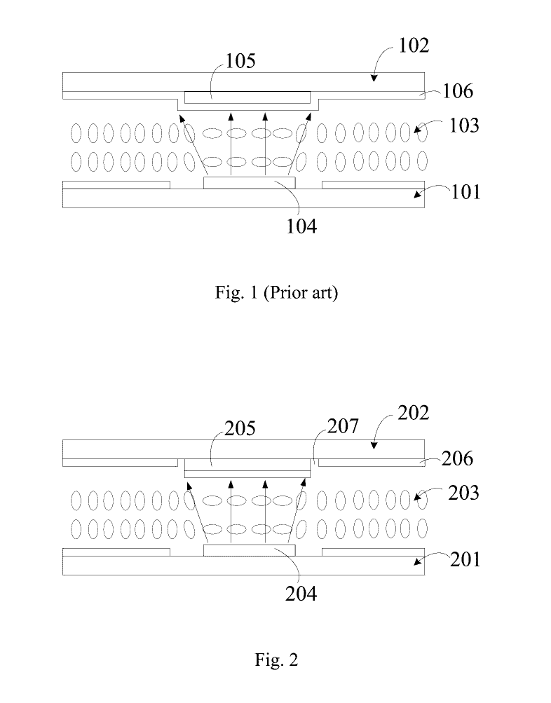

Please refer to FIG. 2. A display panel according to the embodiment of the preent invention comprises an array substrate 201, a color filter substrate 202 and a liquid crystal layer 203 between the array substrate 201 and the color filter substrate 202.

In the embodiment, a plurarity of data lines 204 are set up at interval on the array substrate 201, a black matrix 205 and a transparent electrode 206 are set up on the color filter substrate 202. The data lines 204 and the black matrix 205 are set up in opposition, and the transparent electrode 206 is disposed on the black matrix 205. Gaps 207 are set up on the transparent electrode 206 corresponding to the data lines 204, so that liquid crystal molecules of the liquid crystal layer 203 in the gap 207 do not deflect due to a voltage drop between the data lines 204 and the transparent electrode 206.

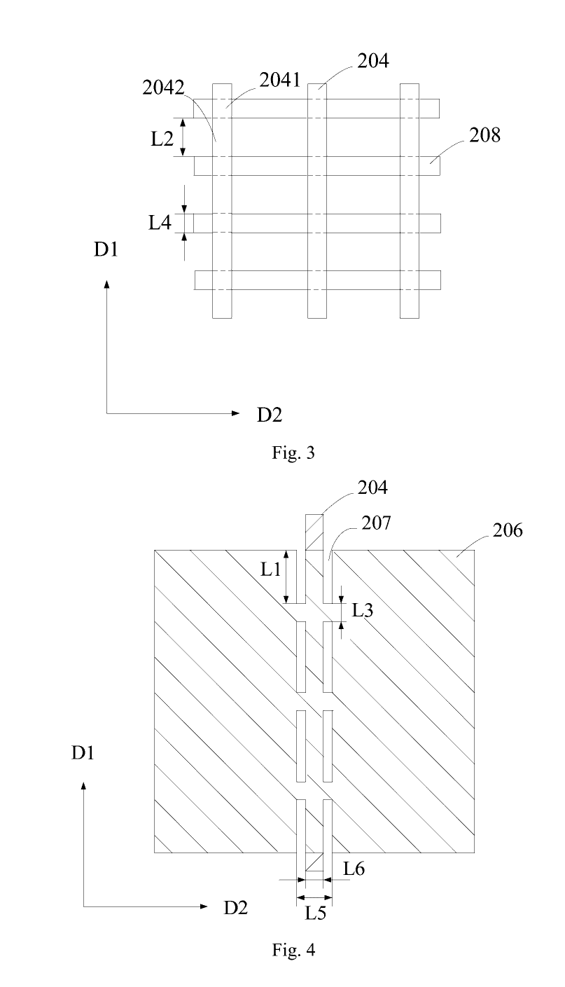

Please refer to FIG. 3. A plurarity of scan lines 208 are set up at interval on the array substrate 201 and insulatively intersect with the data lines 204 which comprises a first area 2041 intersecting with the scan line 208 and a second area 2042 not intersecting with the scan line 208, and the gap 207 is set up in opposition to the second area 2042. A plurarity of data lines 204 extend along a first direction D1 and are set up at interval along a second direction D2 perpendicular to the first direction D1. A plurarity of scan lines 208 extend along the second direction D2 and are set up at interval along the first direction D1. Please refer to FIG. 4 in conjunction, a length L1 of the gap 207 along the first direction D1 is equal to or larger than a length L2 of the second area 2041 along the first direction D1, and a length L3 of the position of the transparent electrode 206 corresponding to the first area 2041 is equal to or smaller than a length L4 of the scan line 208 along the first direction D1.

In the embodiment, the gap 207 is set up at interval along the extending direction of the data lines 204 and locates on the two sides of the fringe of the black matrix 205. The difference between the length L5 of the gap 207 along the second direction D2 and the length of the data lines 204 along D2 is equal to or larger than 10 micrometer (μm) or equal to or smaller than 20 μm.

In the embodiment, the transparent electrode 206 arranges the gap 207. Liquid crystal molecules of the liquid crystal layer 203 in the gap 207 are not affected by the data voltage on the data lines 204 and the voltage on the transparent electrode 206, thus do not deflect. Liquid crystal molecules of the liquid crystal layer 203 in the black matrix 205 deflect due to the data voltage on the data lines 204 and the voltage on the transparent electrode 206, but the permeating light is totally shielded by the black matrix 205, thus vertical crosstalk does not occur.

The embodiment can avoid vertical crosstalk by arranging the gap 207 corresponding to the data line 204 on the transpanrent electrode 206, which avoids deflection of the liquid crystal molecules of the liquid crystal layer 203 in the gap 207 due to the data voltage on the data lines 204 and the voltage on the transpanrent electrode 206.

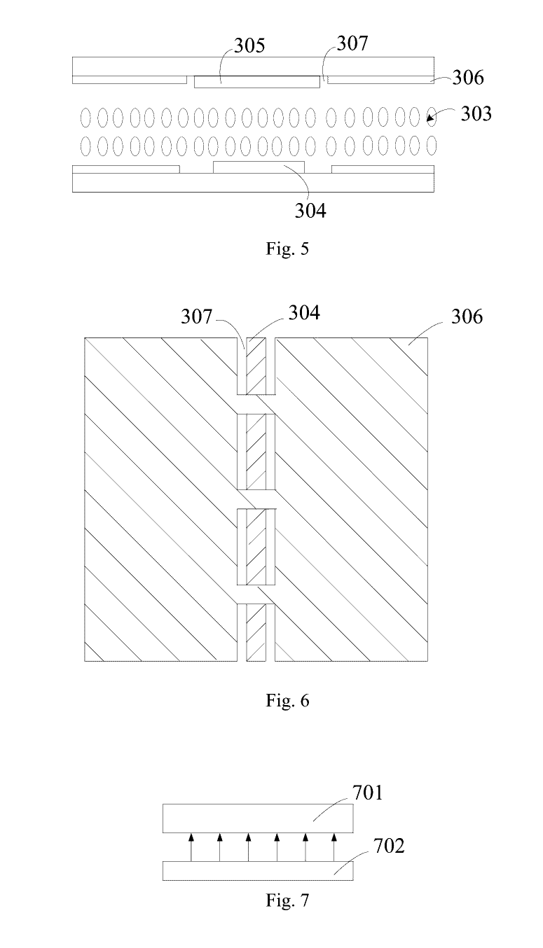

The present invention further provides a display panel according to a second embodiment. The difference between the display panel in the second embodiment and the display panel in the first embodiment is that the width of the gap 307 disclosed in the embodiment is larger than that of the black matrix 305, in order that the black matrix 305 exposes through the gap 307 as FIG. 5 shows. In addition, the gap 307 is set up at interval along the extending direction of the data lines 304, as indicated in FIG. 6.

In the embodiment, the transparent electrode 306 sets up the gap 307. The liquid crystal molecules of the liquid layer 303 in the gap 307 are not affected by the data voltage on the data lines 304 and the voltage on the transparent electrode 306, therefore do not deflect. In hence vertical crosstalk does not occur.

Please refer to FIG. 7. The present invention further provides a display device comprising a display panel 701 and a backlight module 702 providing a light source to the display panel 701, which can be any display panel in the embodiments mentioned above.

In sum, the present invention sets up a gap corresponding to the data lines in the transparent electrode to avoid deflection of the liquid crystal molecules of the liquid crystal layer in the gap due to data voltage on the data lines and voltage on the transparent electrode. Therefore vertical crosstalk does not occur to the display panel.

Those skilled in the art will readily observe, that numerous modifications and alterations of the device may be made while retaining the teachings of the invention. Accordingly, the above disclosure should be construed as limited only by the metes and hounds of the appended claims.

What is claimed is:

1. A display panel comprising an array substrate, a color filter substrate and a liquid crystal layer therebetween, wherein a plurality of data lines are set up at interval on the array substrate, a black matrix and a transparent electrode are set up on the color filter substrate, the plurality of data lines and the black matrix locate in oppostion, the transparent electrode is disposed on the black matrix, and gaps corresponding to the data lines are set up on the transparent electrode.

2. The display panel of claim 1, wherein the geps are set up at interval along an o extending direction of the plurarity of data lines.

3. The display panel of claim 2, wherein a plurarity of scan lines are set up at interval and insulatvely intersect with the plurarity of data lines on the array substrate, each data line comprises a first area intersecting with one of the scan lines and a second area not intersecting with the scan lines, the gap is set up in opposition to the second area.

4. The display panel of claim 3, wherein the plurarity of data lines extend along a first direction and are set up at interval along a second direction perpendicular to the first direction, a length of the gap along the first direction is equal to or larger than that of the second area along the first direction.

5. The display panel of claim 4, wherein a length of the transparent electrode corresponding to the fiest area along the first direction is equal to or smaller than the length of the scan line along the first direction.

6. The display panel of claim 1, wherein the gaps locate on the two sides of the black matrix.

7. The display panel of claim 1, wherein a width of the gap is larger than that of the black matrix so that the black matrix exposes through the gap.

8. The display panel of claim 1, wherein a difference between the length of the gap along the second direction and the length of the data lines along the second direction is equal to or larger than 10 μm and equal to or smaller than 20 μm.

9. A display device comprising a display panel, the display panel comprising an array substrate, a color filter substrate and a liquid crystal layer therebetween, wherein a plurality of data lines are set up at interval on the array substrate, a black matrix and a transparent electrode are set up on the color filter substrate, the plurarity of data lines and the black matrix locate in oppostion, the transparent electrode is disposed on the black matrix, and gaps corresponding to the data lines are set up on the transparent electrode.

10. The display device of claim 9, wherein the geps are set up at interval along an extending direction of the plurarity of data lines.

11. The display device of claim 10, wherein a plurarity of scan lines are set up at interval and insulatvely intersect with the plurarity of data lines on the array substrate, each data line comprises a first area intersecting with one of the scan lines and a second area not intersecting with the scan lines, the gap is set up in opposition to the second area.

12. The display device of claim 11, wherein the plurarity of data lines extend along a first direction and are set up at interval along a second direction perpendicular to the first direction, a length of the gap along the first direction is equal to or larger than that of the second area along the first direction.

13. The display device of claim 12, wherein a length of the transparent electrode corresponding to the fiest area along the first direction is equal to or smaller than the length of the scan line along the first direction.

14. The display device of claim 9, wherein the gaps locate on the two sides of the black matrix.

15. The display device of claim 9, wherein a width of the gap is larger than that of the black matrix so that the black matrix exposes through the gap.

16. The display device of claim 9, wherein a difference between the length of the gap along the second direction and the length of the data lines along the second direction is equal to or larger than 10 μm and equal to or smaller than 20 μm.
